(19) United States
(12) Patent Application Publication
(10) Pub. No.: US 2006/0179630 A1
(43) Pub. Date: Aug. 17, 2006

(54) Method of using multi-ceramic based liquid insulation compositions and textile products coated with multi-ceramic based liquid insulation compositions

(76) Inventors: J. Glenn Davis, Collins, GA (US); Robert T. Loft, Salmon, ID (US); Shala W. Summey III, Moore, SC (US)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 10/910,553

(22) Filed: Aug. 3, 2004

Related U.S. Application Data
(60) Provisional application No. 60/569,909, filed on May 11, 2004.

(51) Int. Cl. B68G 7/00

(52) U.S. Cl. 29/91.1; 29/458; 29/527.1

(57) ABSTRACT

A method of imparting fire-resistant properties, insulation properties, acoustic properties, and/or anti-microbial properties, and/or reducing static electricity propensity, to items including carpet, flooring and/or textile products including woven and/or non-woven products, synthetic products, and/or natural fiber products, includes coating the item with a multi-ceramic based liquid insulation composition.

### CROSS-REFERENCE TO RELATED APPLICATIONS

Priority of U.S. Provisional Patent Application Ser. No. 60/569,909, filed 11 May 2004, incorporated herein by reference, is hereby claimed.

### STATEMENT REGARDING FEDERALLY SPONSORED RESEARCH OR DEVELOPMENT

Not applicable

REFERENCE TO A “MICROFICHE APPENDIX”

Not applicable

### BACKGROUND OF THE INVENTION

1. Field of the Invention

The present invention relates to more fire resistant and thus improved interior furnishing articles (e.g. furniture, bedding, carpeting, textile type wall covering) and exterior building materials (e.g. decking, sheeting, roofing). More particularly, the present invention relates to the use of ceramic or multi-ceramic based liquid insulation compositions added to textile products that are a part of interior furnishings and/or exterior building materials so that they retard the spread of fire.

2. General Background of the Invention

A multi-ceramic based insulation product is commercially available from Superior Products International II, Inc., 10835 West 78 the Street, Shawnee Mission, Kansas 66214, under the product name Super Therm® (hereinafter “The Super Therm® product”). U.S. Registration Number 1,744,170 for the mark “Super Therm®” lists as goods: “fire resistant coating with insulating properties for interior and exterior use on metal, masonry, wood, tar, urethane, foam and rolled surfaces such as roofing and interior and exterior wall surfaces.

The formula of Super Therm® is a trade secret of Superior Products International II, Inc. It contains ethylene glycol, texanol, mica, water borne polyurethane, and various clays. The Super Therm® product is a combination of high-performance acrylic resins in water, which contain no cosolvents and will dry by evaporation. It has two reflective ceramics to reflect sunlight and radiant heat while a third ceramic compound works to stop heat and/or conduction through the coating film, and a fourth ceramic compound blocks infrared (it blocks 99.5% of the infra red heat—the other ceramics block 92% of short wave radiation). The combination of acrylics provide elasticity and toughness with the urethane providing the binding for the acrylics and compound while also providing a moisture barrier.

Sunshield is a multi-ceramic based insulation product commercially available from Superior Products International II, Inc.

The Morgan U.S. Pat. No. 5,474,806 relates to a method of coating a surface of hydrophobic microporous thermal insulation material. U.S. Pat. No. 5,474,806 incorporated herein by reference.

Also incorporated herein by reference is www.rustgrip.com and all information at that web site.

### BRIEF SUMMARY OF THE INVENTION

The present invention includes a method of using a multi-ceramic based liquid insulation composition (such as the Super Therm® product) and articles such as furnishings and exterior building products constructed using textile products, protected with such multi-ceramic based liquid insulation compositions. “Furnishings” as used herein includes furniture, bedding, carpeting and woven fabric wall coverings. “Exterior Building Products” as used herein includes any substrate for roofing, decking, house wrap, or like articles).

The present invention includes the use of a product like Super Therm® in its present state or form, and any variation of such Super Therm® product as it may be altered slightly to properly fit the applications (furnishings and exterior building products) mentioned in the present disclosure.

The multi-ceramic articles of the present invention reducing or eliminating flammability, reducing or eliminating static electricity, and reducing decibel levels. The articles of the present invention also have anti-microbial properties.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a sectional view of the preferred embodiment of the apparatus of the present invention illustrating a non-woven, spun bonded fabric article that can be incorporated in furnishings and exterior building products;

FIG. 2 is a sectional view of the preferred embodiment of the apparatus of the present invention illustrating a woven multi-layer article that can be incorporated in furnishings and exterior building products;

FIG. 3 is a sectional view illustrating the preferred embodiment of the apparatus of the present invention in the form of a furnishing article, namely multi-layered carpeting;

FIG. 4 is a sectional view illustrating the preferred embodiment of the apparatus of the present invention in the form of a furnishing article, namely multi-layered carpeting.

### DETAILED DESCRIPTION OF THE INVENTION

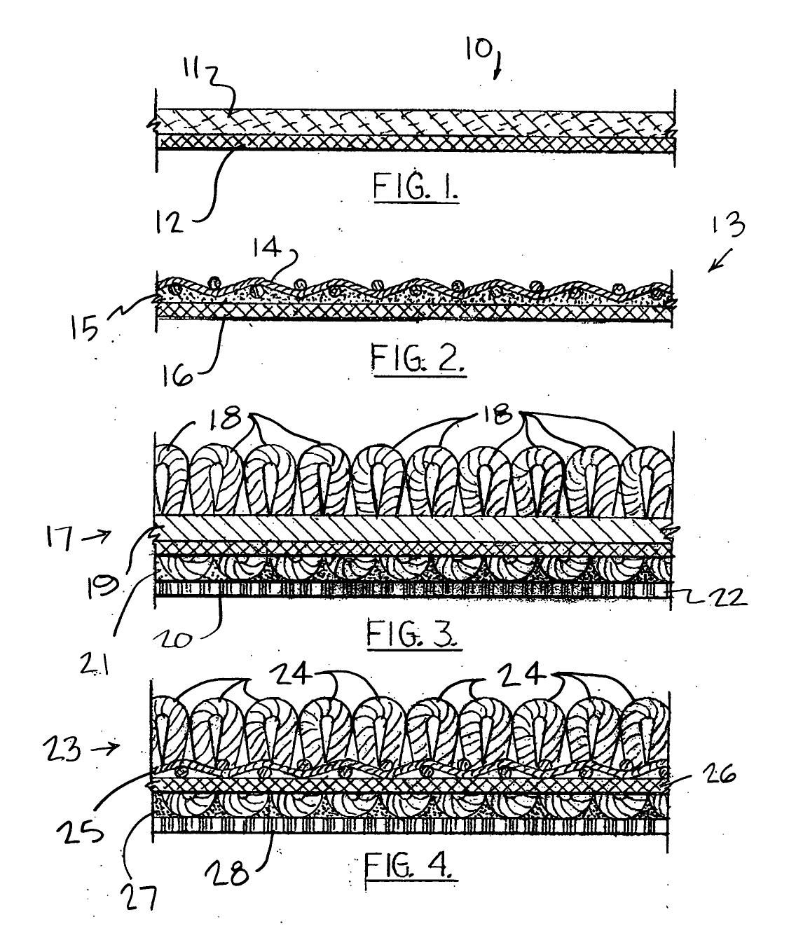

FIG. 1 shows a spun bonded fabric article 10 that can be used in the construction of a furnishing article such as furniture, bedding and the like. When constructing a building such as a home, the spun bonded article 10 can be used as a substrate for roofing material, decking material, or house wrap. Spun bonded article 10 includes a fabric or web layer 11 and a multi-ceramic coating 12.

In FIG. 2, woven article 13 is comprised of a plurality of layers including a woven fabric layer 14, a sizing layer 15, and a multi-ceramic coating layer 16. The woven article 13 can be used in the construction of furnishings (including e.g. furniture and bedding) and interior wall coverings that are desirably of a woven fabric outer surface, such as for sound insulation. The woven article 13 can also be used as an exterior building material such as a substrate for roofing, decking or house wrap.

Carpeting article 17 is shown in FIG. 3. The multi-layer carpeting article 17 includes an outermost or upper layer of yarn tufts 18, a primary (preferably non-woven) backing 19, and a multi-ceramic coating 20. The carpeting article 17 also includes a sizing layer 21 and an attached secondary backing layer 22.

In FIG. 4, another carpeting article 23 is shown. The carpeting article 23 is also multi-layered, including a yarn tufts layer 24, woven primary backing 25, multi-ceramic coating 26, sizing layer 27 and attached secondary backing 28.

The present invention includes a method of using multi-ceramic based liquid insulation compositions (such as the Super Therm® product) and textile products coated with such multi-ceramic based liquid insulation compositions.

The present invention includes the use of a multi-ceramic based liquid insulation composition (such as the Super Therm® product in its present state or form), and any variation of a multi-ceramic based liquid insulation composition (such as the Super Therm® product) as it may be altered slightly to properly fit the applications mentioned in the present disclosure.

The present invention includes the application of Super Therm® and like multi-ceramic-based compositions onto various carpet, flooring and textile products. These textile products include woven and/or non-woven products, synthetic products, and/or natural fiber products (including paper or film). The fiber can be staple fiber or continuous filament fiber or tape.

The present invention includes all methods of application to the textile products, including, but not restricted to, spray, brush, roller, “dope roller”, “kiss coat” or “scrape” or “Dr. Blade”, or direct application (such as spraying in foam form wherein the foam can be created by injecting air into the liquid). The present invention includes a process that involves heated or unheated drying.

The present invention includes all applications in both residential and commercial areas where the end use of the textile product will be for the reduction of flammability or static propensity.

The present invention includes all applications of Super Therm® and like multi-ceramic-based compositions (e.g. the Super Therm® product) to aid in the textile products' ability to enhance insulation, acoustic, or anti-microbial properties.

The aforementioned textile products may be utilized in, but are not restricted to, residential and/or commercial and/or industrial structures. These textile products may be utilized in, but are not limited to, interior applications as well as exterior applications, both for residential and/or commercial and/or industrial applications.

The present invention includes the use (e.g. The Super Therm® product) multi-ceramic-based compositions (e.g. The Super Therm® product) on flooring, sub flooring, house wrap, ceilings, substrates for roofing, furniture and/or any component, bedding and/or any component or any application that utilizes a coated textile fabric in its construction in an exterior application as an underlayment or as a finished product itself.

The present invention includes the use of multi-ceramic-based compositions (e.g. the Super Therm® product) on woven and non-woven textile applications including but not limited to, geo-textile, such as erosion control, road bed material, and underlayment for paved or unpaved roads.

The coating 12, 16, 20, 26 of the present invention can be, for example, 1-20 mils (0.0254-0.508 mm) thick. Preferably, the coating is 2-18 mils (0.0508-0.4572 mm) thick. More preferably, the coating 12, 16, 20, 26 is between about 7-17 mils (0.1778-0.4318 mm) thick. Most preferably, the coating 12, 16, 20, 26 is between about 8-10 mils (0.2032-0.254 mm) thick. The coating 12, 16, 20, 26 can be applied in a single layer, in two layers, in three layers, or in even more layers, though one layer is preferred for most applications.

A single ceramic insulation could be used for layers 12, 16, 20, 26 as the material in the methods and items of FIGS. 1-4 and the present invention, though multi-ceramic-based products (e.g. similar to Super Therm® are preferred.

One skilled in the art, such as a chemist or chemical engineer could formulate other multi-ceramic-based products (e.g. similar to Super Therm®) that could work as well as the Super Therm® product, and the present invention includes the use of these other products in the methods and finished products disclosed herein.

Different resins from those used in Super Therm® could be used for adhesion reasons (the choice of ceramics may be more important than the resins or epoxies used).

Though the Super Therm® product is a liquid composition, a dry composition (perhaps including thermosetting dry resins) could be formulated to use in the method of the present invention.

All measurements disclosed herein are at standard temperature and pressure, at sea level on Earth, unless indicated otherwise.

Parts List

| Parts Number | Description |
|---|---|
| 10 | spun bonded article |
| 11 | fabric layer |
| 12 | multi-ceramic coating |
| 13 | woven article |
| 14 | woven fabric |
| 15 | sizing layer |
| 16 | multi-ceramic coating |
| 17 | carpet |
| 18 | yarn |
| 19 | primary backing |
| 20 | multi-ceramic coating |
| 21 | sizing layer |
| 22 | secondary backing |
| 23 | carpet |
| 24 | yarn |
| 25 | primary backing |
| 26 | multi-ceramic coating |
| 27 | sizing |
| 28 | attached secondary backing |

The foregoing embodiments are presented by way of example only; the scope of the present invention is to be limited only by the following claims.

1. A method of imparting fire retardant properties to a fabric layer, comprising the steps of:
a) coating the fabric layer with a multi-ceramic based composition; and
b) affixing the coated fabric layer of step “a” to a furnishing article.

2. The method of claim 1, wherein the fabric layer is a woven layer.

3. The method of claim 1, wherein the fabric layer is a non-woven layer.

4. The method of claim 1, wherein a coating of 0.0254-0.508 mm is applied to the fabric layer.

5. The method of claim 1, wherein the ceramic based composition of step “a” comprises the product that is sold under the trademark Super Therm®.

6. The method of claim 1, further comprising providing acoustic insulation to the fabric layer in step “a”.

7. The method of claim 1, wherein the coating is an anti-microbial coating.

8. The method of claim 1, wherein the coating in step “a” reduces static electricity.

9. The method of claim 1, wherein in step “a” the coating is applied by spraying.

10. The method of claim 1, wherein in step “a” the coating is applied by brushing.

11. The method of claim 1, wherein in step “a” the coating is applied by rolling.

12. The method of claim 11, wherein in step “a” the rolling is applied with a dope roller.

13. The method of claim 11, wherein in step “a” the rolling is applied with a dope roller as a kiss coat.

14. The method of claim 11, wherein in step “a” the rolling is applied with a dope roller with a scrape blade.

15. The method of claim 1, wherein in step “a” the coating is applied with a direct application.

16. The method of claim 15, wherein in step “a” the coating is applied as a foam.

17. The method of claim 1, further comprising heated the coating to dry it.

18. The method of claim 1, wherein the coating is dried without heating it.

19. A building product coated with a ceramic based insulation composition by the method of claim 1.

20. The invention of claim 19, wherein the article is flooring.

21. The invention of claim 19, wherein the article is sub-flooring.

22. The invention of claim 19, wherein the article is house wrap.

23. The invention of claim 19, wherein the article is a part of a ceiling.

24. The method of claim 1, wherein in step “b” the article is furniture.

25. The method of claim 1, wherein in step “b” the article is bedding.

26. The method of claim 1, wherein in step “b” the article is a substrate for roofing.

27. The method of claim 1, wherein in step “b” the article includes a coated textile fabric in its construction and in an exterior surface application.

28. The method of claim 1, wherein the article is geo-textile.

29. The invention of claim 19, wherein the item is from the group consisting of textiles, housewrap, flooring, geotextile and, substrates for lining mines.

30. The method of claim 1, wherein the multi-ceramic based liquid insulation composition includes reflective ceramics that reflect radiant energy and ceramic that has low heat conductivity.

31. The method of claim 1, wherein the multi-ceramic based composition is a liquid.

32. The method of claim 31, wherein the multi-ceramic based composition provides insulation.

33. The method of claim 1, wherein the woven layer includes fibers that are a staple or continuous filament fiber or tape.

34. A method of fire retarding a furniture article, comprising the steps of:
a) providing a layer of textile fabric;
b) adding a ceramic layer to the layer of textile fabric;
c) covering at least part of the furniture article with the textile fabric of step “a”.

35. The method of claim 1, wherein the layer of ceramic is between about 0.0254-0.508 mm.

36. The method of claim 34, wherein the ceramic layer comprises in part the product that is sold under the trademark Super Therm®.

37. The method of claim 35, wherein in steps “a” and “b” the fabric has a backing that includes the ceramic layer.

38. The method of claim 34, wherein in step “a” the textile fabric has opposed surfaces, and in step “b” at least one of the surfaces is provided with the ceramic layer.

39. The method of claim 34, wherein in step “b” the fabric is at least partially impregnated with the ceramic layer.

40. The method of claim 34, wherein the ceramic layer is applied by spraying.

41. The method of claim 34, wherein in step “b” the ceramic layer is added by brushing.

42. The method of claim 34, wherein in step “b” the ceramic layer is added by rolling.

43. The method of claim 34, wherein in step “b” the ceramic layer is applied as a foam.

44. The method of claim 34, wherein the ceramic layer is heated to dry it.

45. The method of claim 34, wherein the ceramic layer is dried without heating it.

46. The method of claim 34, wherein the article is a seating unit.

47. The method of claim 34, wherein the article is a bedding unit.

48. The method of claim 47, wherein the article is a mattress.

49. The method of claim 47, wherein the article is a box spring unit.

50. The method of claim 34, wherein the article is carpeting.

51. The method of claim 34, wherein the article is used in an application that utilizes a coated textile fabric in its construction in an exterior building application.

52. The method of claim 51, wherein the article is a housewrap.

53. The method of claim 34, wherein the ceramic in step “b” is a multi-ceramic based liquid insulation composition.

54. The method of claim 51, wherein the article is a roofing layer.

55. The method of claim 51, wherein the article is a decking layer.

56. The method of claim 34, wherein the layer of fabric includes a non-woven layer.

57. The method of claim 34, wherein the layer of fabric includes a woven layer.
